(19) United States
(12) Patent Application Publication
(10) Pub. No.: US 2025/0083826 A1
(43) Pub. Date: Mar. 13, 2025

(54) POWER SUPPLY SYSTEM FOR URBAN AIR MOBILITY AND POWER SUPPLY METHOD USING SAME

(71) Applicants: Hyundai Motor Company, Seoul (KR); Kia Corporation, Seoul (KR)

(72) Inventor: Kyoung Joo KIM, Daejeon (KR)

(21) Appl. No.: 18/955,647

(22) Filed: Nov. 21, 2024

Related U.S. Application Data
(62) Division of application No. 18/080,072, filed on Dec. 13, 2022.

(30) Foreign Application Priority Data
Dec. 31, 2021 (KR) 10-2021-0194657

(51) Int. Cl. B64D 27/34; B60L 53/16; B64F 1/35; B64F 3/02; B64U 10/60; B64U 101/25; H01R 13/00

(52) U.S. Cl. CPC B64D 27/34; B60L 53/16; B64F 1/35; B64F 3/02; B64U 10/60; H01R 13/00; B60L 2200/10; B64U 2101/25

(57) ABSTRACT

An urban air mobility power supply system includes an urban air mobility (UAM) device and a power supply drone docked with the UAM device using electromagnetic force to supply external power, and a power supply method, in which the UAM device 200 and the power supply drone are accurately aligned with each other using electromagnets provided in the UAM device and the power supply drone to supply power, and the UAM device and the power supply drone can be easily separated from each other using electromagnetic force.

### CROSS-REFERENCE TO RELATED APPLICATIONS

This patent application is a divisional (and claims the benefit of priority under 35 USC 120) of U.S. patent application Ser. No. 18/080,072, filed Dec. 13, 2022, which claims the benefit of Korean Patent Application No. 10-2021-0194657, filed on Dec. 31, 2021, which is hereby incorporated by reference as if fully set forth herein.

### TECHNICAL FIELD

The present disclosure relates to an urban air mobility power supply system and method, and more specifically, to an urban air mobility power supply system and method capable of controlling alignment of an urban air mobility device and a device that supplies external power using electromagnetic force.

### BACKGROUND

Urban Air Mobility (UAM) devices use the sky as a movement path by being combined with a personal air vehicle (PAV) capable of vertical take-off and landing (VTOL). Urban air mobility (UAM) devices, that are short-distance urban mobility systems, are flying means that vertically take off from a city center, move to a destination, and then vertically land at the destination.

Urban air mobility devices have emerged to solve problems such as decrease in mobility due to congestion in a city center and rapid increase in social costs such as logistics and transportation costs. In modern society where long-distance travel time has increased and traffic congestion has become severe, urban air mobility devices are regarded as a future innovation project capable of solving such problems.

However, if a UAM device is powered by a battery without using a conventional fossil fuel, a large number of batteries needs to be loaded in the UAM device for operating for a long time, but battery capacity increase causes the weight of the UAM device to increase and thus more batteries need to be mounted for the heavy UAM device.

A UAM device, an electric airplane with vertical take-off and landing features that can accommodate multiple people, requires a method for increasing energy density while reducing a battery weight for efficient operation. However, such a technology does not exist at the current stage, and thus a method for mounting a small number of batteries in an airplane is required.

An airplane consumes more energy during takeoff than during flight. For a heavy airplane to take off to an operational altitude (500 to 600 m), a lot of energy is required.

It is necessary to supply power to an airplane during takeoff and to separate a power cable after takeoff. Here, if the power cable is simply separated from the airplane that has taken off, a dangerous situation in which a person or facility on the ground is impacted by the free falling power cable may occur. Accordingly, there is a need for a system for safely supplying external power when an urban air mobility device vertically takes off.

### SUMMARY

An object of the present disclosure is to provide an urban air mobility power supply system and method capable of supplying power required when an urban air mobility device takes off to the urban air mobility device.

Another object of the present disclosure is to provide an urban air mobility power supply system and method capable of safely returning a power cable for supplying power to an urban air mobility device taking off.

To achieve these objects and other advantages and in accordance with the purpose of the disclosure, as embodied and broadly described herein, an urban air mobility (UAM) power supply system includes a power supply drone configured to dock with a UAM device using electromagnetic force in the sky above a charging station to supply external power and to safely return a power cable to the ground after takeoff of the UAM device.

In the UAM power supply system according to the present disclosure, electromagnetic force of electromagnets is used when the UAM device 200 and the power supply drone are docked with/separated from each other.

In the UAM power supply system according to the present disclosure, a power receiver of the UAM device may include a power connection terminal connected to a battery, a pair of first electromagnets disposed on both sides of the power connection terminal, and a plurality of guide pin insertion portions disposed on both sides of the pair of first electromagnets.

In the UAM power supply system according to the present disclosure, the power supply drone may include a power cable connected to the charging station, a power supply unit coupled to the power receiver of the UAM device to transmit power provided through the power cable, and a propulsion device configured to provide propulsion for controlling a position of the power cable.

In the UAM power supply system according to the present disclosure, the power supply unit may include a housing, a power supply terminal having one end connected to the power cable to transmit power to the power receiver, a plurality of guide pins formed on the upper surface of the housing and coupled to the guide pin insertion portions of the power receiver, and a pair of second electromagnets disposed at the upper part of the inside of the housing.

In the UAM power supply system according to the present disclosure, the power receiver may include a camera marker, and the power supply unit may include a camera configured to capture an image of the camera marker.

In the UAM power supply system according to the present disclosure, the camera marker may be disposed to be biased toward one side from the center of the power receiver, and the camera may be disposed to be biased to one side from the center of the upper surface of the housing.

In the UAM power supply system according to the present disclosure, the guide pin insertion portions include a fixing device for fixing the guide pins, and a recess corresponding to the fixing device is formed on one side of each guide pin.

In the UAM power supply system according to the present disclosure, when the UAM device and the power supply drone are separated from each other, the first electromagnets of the UAM device and the second electromagnets of the power supply drone have opposite polarities after the fixing device is separated from the guide pins such that the power supply drone can be separated from the UAM device.

In the UAM power supply system according to the present disclosure, the power supply drone may charge the battery of the UAM device when the UAM device is in an anchored state, and when the UAM device takes off, supply necessary power to the UAM device by docking with the UAM device.

In the UAM power supply system according to the present disclosure, the power supply drone may release docking with the UAM device when the UAM device has taken off, dock with another UAM device scheduled to land at the same charging station, and return to the charging station.

In the UAM power supply system according to the present disclosure, the power supply drone may supply power to the other UAM device while returning to the charging station.

In the UAM power supply system according to the present disclosure, the power supply drone may control a magnitude of the electromagnetic force according to a distance from the UAM device during docking.

In the UAM power supply system according to the present disclosure, the power supply drone may adjust the magnitude of the electromagnetic force to a first magnitude to align a position with respect to the UAM device when the distance to the UAM device is a first distance, and adjust the magnitude of the electromagnetic force to a second magnitude to come into contact with the UAM device when the distance to the UAM device is a second distance shorter than the first distance.

An urban air mobility (UAM) power supply method according to the present disclosure may include a UAM device transmitting an external power supply request signal in the sky above a charging station, a power supply drone coupling to the lower part of the UAM device in the sky above the charging station using electromagnetic force upon reception of the external power supply request signal from the UAM device, the power supply drone supplying power provided through a power cable connected to the charging station to the UAM device, and the power supply drone being separated from the lower part of the UAM device.

### BRIEF DESCRIPTION OF THE DRAWINGS

FIG. 1 is a diagram illustrating a UAM power supply system according to an implementation of the present disclosure.

FIG. 2 and FIG. 3 are diagrams illustrating the operation of the UAM power supply system according to an implementation of the present disclosure.

FIG. 4 is a block diagram schematically illustrating a configuration of a UAM device according to an implementation of the present disclosure.

FIG. 5 is a block diagram schematically illustrating a configuration of a power supply drone according to an implementation of the present disclosure.

FIG. 6 is a plan view of the power supply drone according to an implementation of the present disclosure.

FIG. 7 is a cross-sectional view taken along line C-C′ of FIG. 6.

FIG. 8 is a plan view of a power receiver of the UAM device according to an implementation of the present disclosure.

FIG. 9 is a flowchart illustrating a process of a UAM power supply method according to an implementation of the present disclosure.

FIG. 10 and FIG. 11 are diagrams for describing an operation of physically connecting the power supply drone and the UAM device according to an implementation of the present disclosure.

FIG. 12 is a graph showing the attractive force between electromagnets according to the distance between the power supply drone and the UAM device.

FIG. 13 is an exemplary diagram according to an implementation of a guide pin and a fixing device.

FIG. 14 is an exemplary diagram according to another implementation of a guide pin and a fixing device.

FIG. 15 is an exemplary diagram showing that the power supply drone and the UAM device perform docking and separating operations according to polarities of electromagnets.

### DETAILED DESCRIPTION

Specific structural and functional descriptions of implementations of the present disclosure disclosed in the present specification or application are illustrated for the purpose of describing implementations according to the present disclosure, and implementations according to the present disclosure may be implemented in various forms and should not be construed as being limited to the implementations described in the present specification and application.

While implementations according to the present disclosure are susceptible to various modifications and alternative forms, specific implementations are shown by way of example in the drawings. However, the present disclosure should not be construed as limited to the implementations set forth herein, but on the contrary, the present disclosure is to cover all modifications, equivalents, and alternatives falling within the spirit and scope of the present disclosure.

The terms “first” and/or “second” are used to describe various components, but such components are not limited by these terms. The terms are used to discriminate one component from another component. For example, a first component may be called a second component and the second component may be called the first component within the technical spirit of the present disclosure.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components. Further, other representations describing a relationship between components, that is, “between”, “immediately between”, “adjacent to” and “directly adjacent to” should be construed likewise.

The terms used in the specification of the present disclosure are merely used in order to describe particular implementations, and are not intended to limit the scope of the present disclosure. An element described in the singular form is intended to include a plurality of elements unless the context clearly indicates otherwise. In the specification of the present disclosure, it will be further understood that the term “comprise” or “include” specifies the presence of a stated feature, figure, step, operation, component, part or a combination thereof, but does not preclude the presence or addition of one or more other features, figures, steps, operations, components, or combinations thereof.

All the terms that are technical, scientific or otherwise agree with the meanings as understood by a person skilled in the art unless defined to the contrary. Common terms as found in dictionaries should be interpreted in the context of the related technical writings not too ideally or impractically unless expressly disclosed herein.

When an implementation can be implemented differently, functions or operations specified in a specific block may be performed differently from the order specified in a flowchart. For example, two consecutive blocks may be performed substantially simultaneously, or the blocks may be reversely performed according to related functions or operations.

Hereinafter, an urban air mobility (UAM) power supply system and method according to the present disclosure will be described with reference to the accompanying drawings.

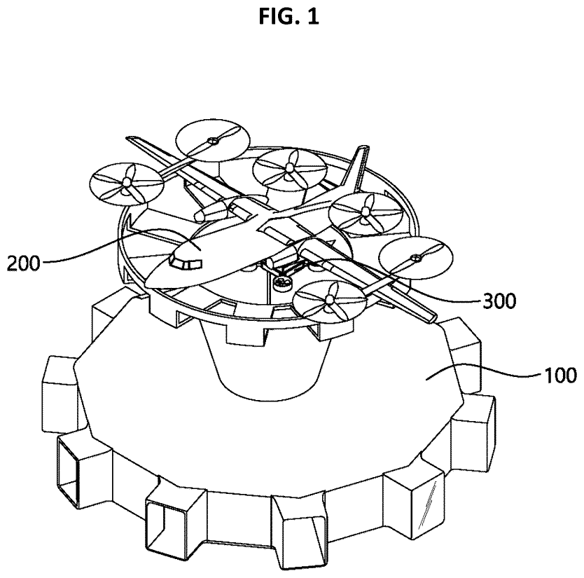

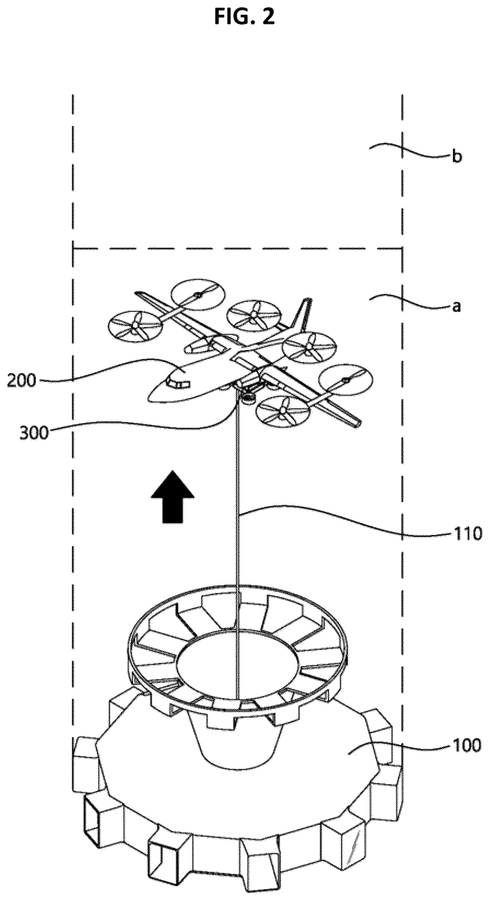

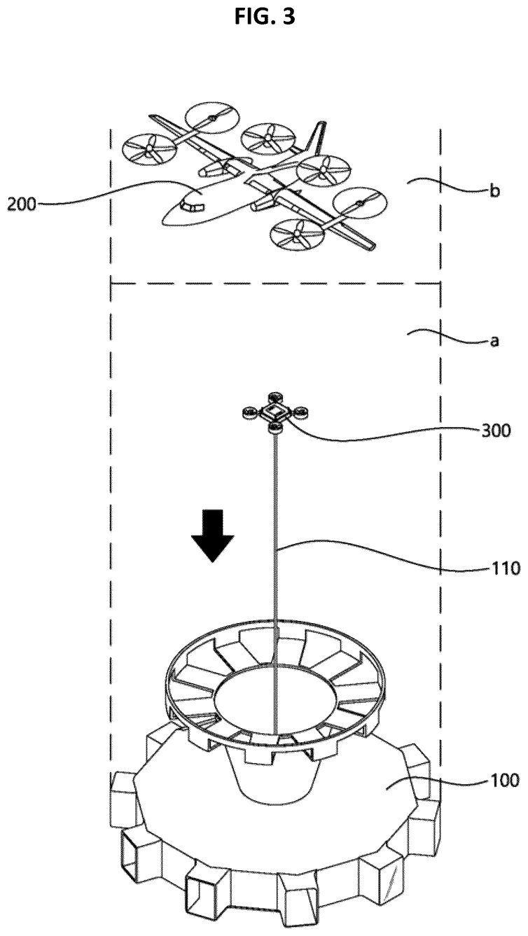

FIG. 1 is a diagram illustrating a UAM power supply system according to an implementation of the present disclosure and FIG. 2 and FIG. 3 are diagrams illustrating an operation of the UAM power supply system according to an implementation of the present disclosure.

Referring to FIG. 1 to FIG. 3, the UAM power supply system according to an implementation of the present disclosure may include a UAM device 200, a power supply drone 300, and a charging station 100.

The UAM device 200 may be an aircraft that can fly freely in the sky and can take off and land vertically even in a narrow space. The UAM device 200 may be defined as an aircraft in which an individual or a large number of passengers can freely fly in the sky in the city center.

The UAM device 200 may include one or more rotors because boarding/deboarding in the city center should be fast and comfortable. When at least one of the rotors provided in the UAM device 200 malfunctions, flight balance can be controlled through the remaining rotors. That is, distributed electric propulsion (DEP) for independently driving multiple rotors may be applied to the UAM device 200 for noise reduction and accident prevention. DEP allows multiple rotors to be driven independently with power or electrical energy generated by a single battery. Even if an individual rotor has a problem, other rotors are continuously driven because DEP is applied to the UAM device 200 and thus the UAM device 200 can safely fly. In addition, the UAM device 200 uses smaller rotors than a helicopter and operates only necessary rotors depending on flight conditions such as takeoff, landing, and flying, and thus noise generation can be minimized.

In addition, distributed electric propulsion (DEP) applied to the UAM device 200 may also be applied to the power supply drone 300.

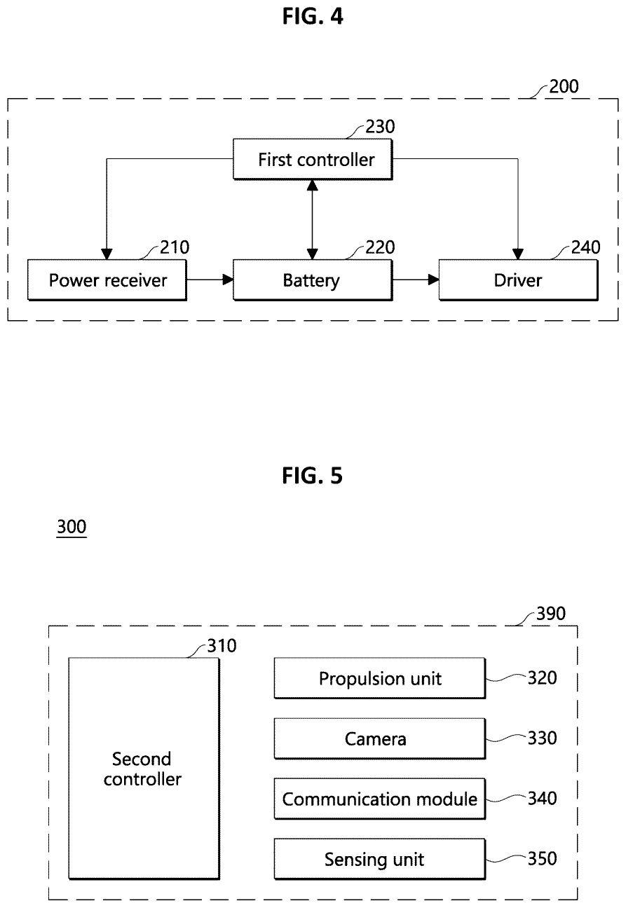

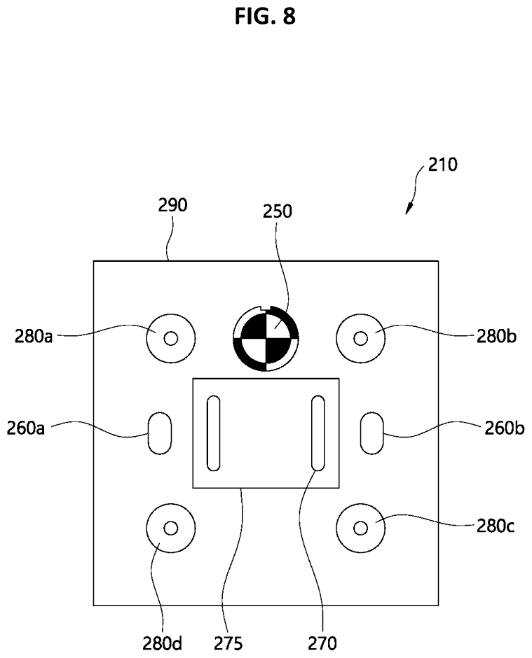

The above-described UAM device 200 may be provided with a connection terminal 270 (refer to FIG. 8) on the bottom surface thereof. The UAM device 200 may receive power or electrical energy through the connection terminal 270 (refer to FIG. 8), store the power or electrical energy in a battery 220 (refer to FIGS. 4, 10 and 11), individually provide the power or electrical energy stored in the battery 220 (refer to FIG. 4) to each rotor, and provide the same to various components mounted in the UAM device 200.

The power supply drone 300 includes at least one rotor 320 and can fly in the sky using the rotor. The power supply drone 300 may supply power to the UAM device 200 that is on the ground or is flying using a supply terminal 370 electrically and physically connected to a power cable 110. For example, the power supply drone 300 may be disposed between the charging station 100 and the UAM device 200 and supply power to the UAM device 200. The power supply drone 300 may be referred to as an auxiliary power drone (APD).

Referring to FIG. 2, the power supply drone 300 may be mounted on the UAM device 200 flying in a preset space and supply power to the UAM device 200 while flying with the UAM device 200. That is, the power supply drone 300 may be mounted on the UAM device 200 and ascend to supply power to the UAM device 200 until the UAM device 200 removed from the charging station 100 reaches a position in a preset space a in the air.

Referring to FIG. 3, the power supply drone 300 may be separated from the UAM device 200 and descend to be mounted on the charging station 100 when the UAM device 200 flies into a space b outside the preset space a.

The power supply drone 300 may include the supply terminal 370 electrically connected to or separated from the connection terminal 270 (refer to FIG. 8) of the UAM device 200. The supply terminal 370 may be electrically connected to the power cable 110. The power supply drone 300 may include a fixing part that can firmly fix the power cable 110 in order to prevent the power cable 110 from being arbitrarily detached or separated from the power supply drone 300.

The charging station 100 is disposed on the ground and may include the power cable 110 having a predetermined length. The power cable 110 may be used to supply power to the UAM device 200 through the supply terminal 370 of the power supply drone 300 electrically connected thereto under the control of the charging station 100.

As shown in FIG. 2, the charging station 100 may control the power cable 110 such that the power cable 110 continues to be unwound on the basis of position information and flight information of the power supply drone 300 received from the power supply drone 300 until the UAM device 200 is removed from the charging station 100 and reaches a position in the preset space a in the air. Accordingly, the power supply drone 300 can stably supply power to the UAM device 200.

In addition, the charging station 100 may receive position information and flight information of the power supply drone 300 in real time from the power supply drone 300 that has been separated from the UAM device 200 flying in the space b out of the preset space a and control the power cable 110 such that it is gradually wound on the basis of the position information and the flight information, as shown in FIG. 3. Accordingly, the power supply drone 300 can prevent the power cable 110 from deviating from the preset space a during descending under the control of the charging station 100.

FIG. 4 is a block diagram schematically illustrating a configuration of the UAM device according to an implementation of the present disclosure. The UAM device 200 may include a power receiver 210, a battery 220, a driver 240, and a first controller 230.

The power receiver 210 receives power from the power supply drone 300. The battery 220 stores power transmitted through the power receiver 210, and the driver 240 drives the UAM device 200 using the power stored in the battery 220. The first controller 230 controls the power receiver 210, the battery 220, and the driver 240.

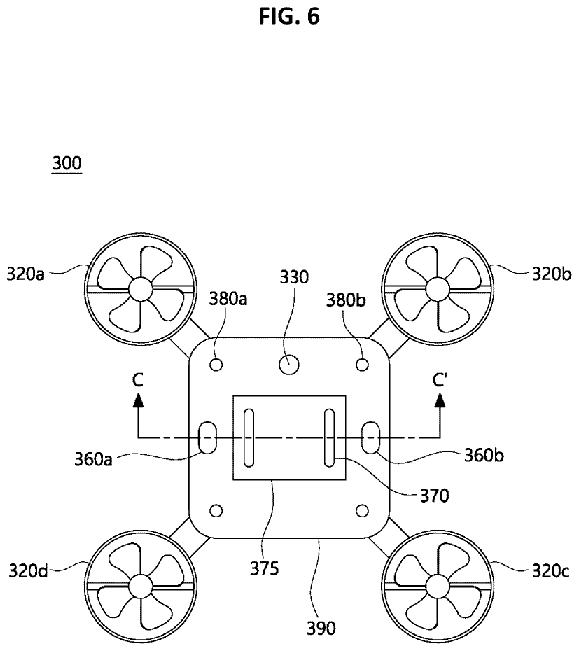

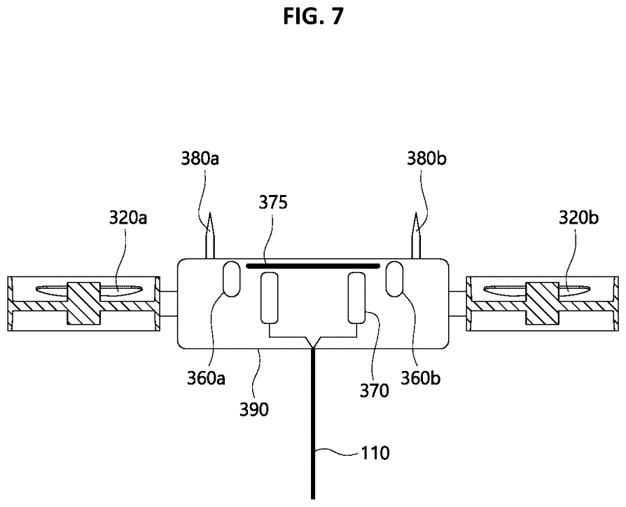

FIG. 5 is a block diagram schematically illustrating a configuration of the power supply drone according to an implementation of the present disclosure, FIG. 6 is a plan view of the power supply drone according to an implementation of the present disclosure, and FIG. 7 is a cross-sectional view taken along line C-C′ of FIG. 6.

The power supply drone 300 according to an implementation of the present disclosure includes a second controller 310, a body 390, a propulsion unit 320, a camera 330, a communication module 340, and a sensing unit 350. The present disclosure is not limited thereto and components may be omitted or added as necessary.

The body 390 has a predetermined internal space and may be formed to a predetermined thickness. For example, the body 401 may be formed so as to have an upper surface, a lower surface, and four sides (or lateral surfaces). The present disclosure is not limited thereto and the body 401 may have any shape as long as a plurality of propulsion units 320, which will be described later, can be firmly fastened or mounted thereto.

The body 390 may have the supply terminal 370 disposed at a part of the upper surface. Further, the body 390 may have guide pins 380a to 380d and the camera 330 disposed to be spaced apart from the supply terminal 370 on the upper surface. Details will be described later with reference to FIG. 6.

The propulsion unit 320 is disposed on the circumferential surface of the body 390 and may operate to cause the power supply drone 300 to fly. The propulsion unit 320 may be referred to as a rotor. The propulsion unit 320 may operate by receiving electrical energy or power from the power cable 110 according to a control signal of the second controller 310.

A plurality of propulsion units 320 may be provided. For example, the propulsion unit 320 includes a first rotor 320a, a second rotor 320b, a third rotor 320c, and a fourth rotor 320d. The first rotor 320a to the fourth rotor 320d may fly the power supply drone 300 in the ascending or descending direction or in the forward, backward, left, and right directions under the control of the second controller 310.

The second controller 310 may be disposed in the internal space of the body 390 to be electrically connected to a plurality of components mounted on the power supply drone 300. That is, the second controller 310 may control a plurality of hardware or software components electrically connected to the second controller 310 by executing an operating system or an application program and perform processing/operations of various types of data including data related to the propulsion unit 320. The second controller 310 may be referred to as a mobility control unit (MCU).

The second controller 310 may be configured as a single integrated circuit (IC). For example, the second controller 310 may include a system on chip (SoC), a graphics processing unit (GPU), or the like.

The second controller 310 may control the communication module 340 to execute functions of managing data links and converting communication protocols in communication between the power supply drone 300 and the UAM device 200, the charging station 100, or another power supply drone 300 connected through a network. The second controller 310 may control data transmission/reception of the communication module 340.

The second controller 310 may load a command or data received from at least one of a non-volatile memory or other components connected thereto into a volatile memory and process the same. In addition, the second controller 310 may store data received from or generated by at least one of the other components in the nonvolatile memory.

The second controller 310 having the above-described functions may control the propulsion unit 320 such that the power supply drone 300 is mounted on the UAM device 200 or the charging station 100 or separated therefrom. The second controller 310 may operate by receiving power from the power cable 110 or the battery 220 and control a plurality of components.

The camera 330 may be disposed on the upper surface of the body 390 and may capture an image of a camera marker 250 (refer to FIG. 8) while mounted on the UAM device 200 under the control of the second controller 310. The camera 330 may capture an image of the power supply drone 300 and the UAM device 200 while the power supply drone 300 is mounted on or docked with the UAM device 200 and provide the captured image to the second controller 310. The second controller 310 may calculate a distance between the power supply drone 300 and the UAM device 200 on the basis of the captured image.

The communication module 340 may transmit flight information and position information of the power supply drone 300 to the UAM device 200 or the charging station 100 under the control of the second controller 310. The communication module 340 may receive flight information and position information of the UAM device 200 from the UAM device 200 or receive position information of the charging station 100 from the charging station 100. The communication module 340 may include a wireless communication module 340 or an RF module.

The wireless communication module 340 may include Wi-Fi, BT, GPS or NFC. For example, the wireless communication module 340 may provide a wireless communication function using a radio frequency. Additionally or alternatively, the wireless communication module 340 may include a network interface, a modem, or the like for connecting the power supply drone 300 to a network (e.g., the Internet, a LAN, a WAN, a telecommunication network, a cellular network, a satellite network, POTS, a 5G network, or the like).

The RF module may serve to transmit/receive data, for example, transmit/receive RF signals or called electronic signals. For example, the RF module may include a transceiver, a power amplifier module (PAM), a frequency filter, a low noise amplifier (LNA), or the like.

The sensing unit 350 may be disposed on the body 390 to sense a position state of the power supply drone 300. The sensing unit 350 may include at least one sensor. For example, the sensing unit 350 may include at least one of a gyro sensor, an air pressure sensor, a magnetic sensor, an acceleration sensor, a proximity sensor, a temperature/humidity sensor, and an illuminance sensor. The sensing unit 350 may sense a position or operating state of the power supply drone 300 under the control of the second controller 310 and convert measured or sensed information into an electrical signal. The sensing unit 350 may be referred to as a sensor module or a sensing module.

In some implementations, the power supply drone 300 may include a memory. The memory may include a built-in memory or an external memory. The built-in memory may include at least one of a volatile memory (e.g., dynamic RAM (DRAM), static RAM (SRAM), synchronous dynamic RAM (SDRAM), etc.) and a non-volatile memory (e.g., one-time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an implementation, the built-in memory may take the form of a solid state drive (SSD). The external memory may include a flash drive, for example, compact flash (CF), secure digital (SD), micro secure digital (micro-SD), mini secure digital (mini-SD), extreme digital (xD), a memory stick, etc.

FIG. 6 is a plan view of the power supply drone according to an implementation of the present disclosure and FIG. 7 is a cross-sectional view taken along line C-C′ of FIG. 6. The power supply drone 300 may include the propulsion unit 320, the supply terminal 370, guide pins 380a to 380d, the camera 330, a terminal protector 375, and a pair of electromagnets 360a and 360b.

A plurality of propulsion units 320 may be disposed on the circumferential surface or the sides of the body 390. Although FIG. 5 illustrates that the propulsion units 320 are disposed at corners between neighboring sides, the present disclosure is not limited thereto. The propulsion unit 320 may be referred to as a propulsion device or a rotor.

The propulsion unit 320 may include the first rotor 320a, the second rotor 320b, the third rotor 320c, and the fourth rotor 320d.

The first rotor 320a may be disposed on the left front side of the upper surface of the body 390. The second rotor 320b may be disposed on the right front side of the upper surface of the body 390. The third rotor 320c may be disposed on the right rear side of the upper surface of the body 390. The fourth rotor 320d may be disposed on the left rear side of the upper surface of the body 390.

The first rotor 320a to the fourth rotor 320d may operate individually or together under the control of the second controller 310 to allow the power supply drone 300 to fly in the ascending or descending direction or in the forward, backward, left, and right directions. For example, the first to fourth rotors 320a to 320d can push the air downward to create lift or propulsion and use the lift or propulsion to allow the power supply drone 300 to fly.

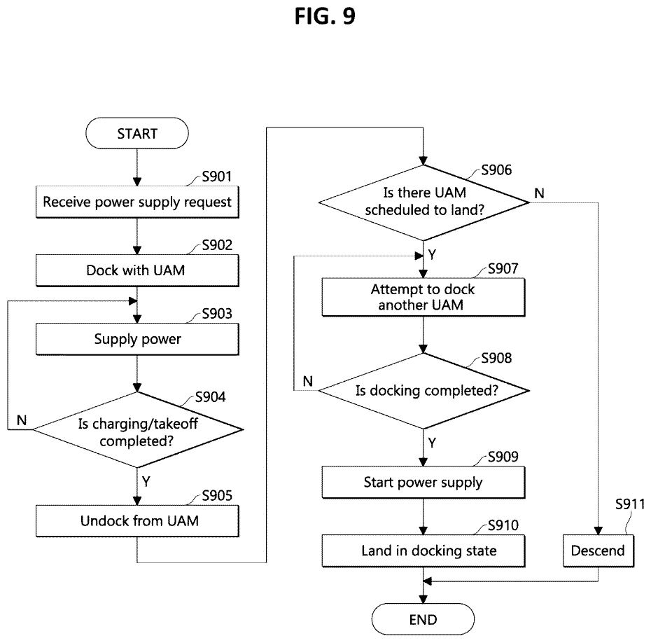

The supply terminal 370 may be disposed at the center of the upper surface of the body 390 and may be electrically connected to or separated from the connection terminal 270 (refer to FIG. 9) of the power receiver 210 of the UAM device 200 which will be described later. The supply terminal 370 may be electrically connected to the power cable 110 connected to the charging station 100.

The supply terminal 370 may be formed in a bar shape having a predetermined thickness and length. The supply terminal 370 may be formed of a metal material to supply power or electrical energy to the connection terminal 270 (refer to FIG. 9).

The terminal protector 375 may be embedded in the body 390 and may be disposed on the upper surface of the body 390 such that a part thereof surrounds the supply terminal 370. The terminal protector 375 may serve to protect the supply terminal 370 from the outside. The terminal protector 375 may be formed to cover the supply terminal 370 disposed on the upper surface of the body 390. That is, the terminal protector 375 may be formed to be flexible.

The terminal protector 375 may perform an opening operation to expose the supply terminal 370 to the outside or a closing operation to protect the supply terminal 370 from the outside under the control of the second controller 310. The terminal protector 375 may be referred to as a supply terminal door. A detailed description thereof will be provided later.

The guide pins 380a to 380d may be disposed on the upper surface of the body 390 and may protrude in a direction in which the power supply drone 300 is mounted on the UAM device 200 such that the guide pins 380a to 380d are inserted into guide pin insertion portions 280a to 280d (refer to FIG. 9) of the power receiver 210 of the UAM device 200 which will be described later. The guide pins 380a to 380d may be formed to protrude upward.

The guide pins 380a to 380d may be disposed on the upper surface of the body 390 such that they are not superposed on the supply terminal 370 or the terminal protector 375.

The guide pins 380a to 380d may include the first guide pin 380a to the fourth guide pin 380d.

The first guide pin 380a may be disposed on the left front side of the upper surface of the body 390. The second guide pin 380b may be disposed on the right front side of the upper surface of the body 390. The third guide pin 380c may be disposed on the right rear side of the upper surface of the body 390. The fourth guide pin 380d may be disposed on the left rear side of the upper surface of the body 390.

As described above, in the present disclosure, the first guide pin 380a to the fourth guide pin 380d are disposed on the upper surface of the body 390, and thus the power supply drone 300 can be more correctly aligned with the UAM device 200.

Although FIG. 6 illustrates four guide pins 380a to 380d, the number of guide pins 380a to 380d is not limited thereto.

The camera 330 may be disposed on the upper surface of the body 390 between the first guide pin 380a and the second guide pin 380b. The second controller 310 may induce the power supply drone 300 to be aligned with the UAM device 200 at a correct position by receiving a captured image from the camera 330.

The pair of electromagnets 360a and 360b is disposed at the upper part of the inside the body 390 to facilitate docking with/separating from the UAM device 200. It is desirable that the electromagnets 360a and 360b be disposed outside the supply terminal 370 and respectively positioned between the first guide pin 380a and the fourth guide pin 380d and between the second guide pin 380b and the third guide pin 380c.

FIG. 8 is a plan view of the UAM device according to an implementation of the present disclosure. Referring to FIG. 8, the UAM device 200 according to an implementation of the present disclosure may include the connection terminal 270, the guide pin insertion portions 280a to 280d, the camera marker 250, and a pair of electromagnets 260a and 260b on the lower surface thereof facing the upper surface of the power supply drone 300.

The connection terminal 270 may be disposed at the center of the lower surface at a position corresponding to the supply terminal 370 and electrically connected to or separated from the supply terminal 370 of the power supply drone 300. The connection terminal 270 may be formed to be connected to the supply terminal 370 in such a manner that the supply terminal 370 is inserted thereinto.

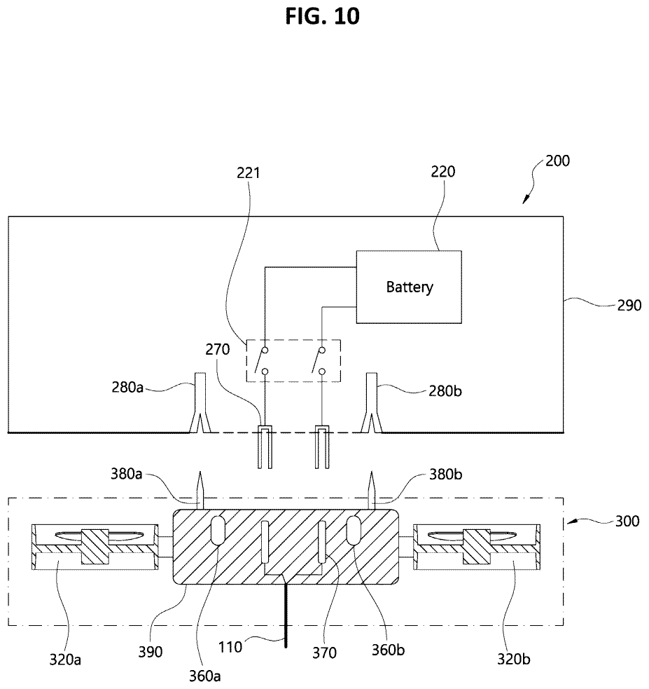

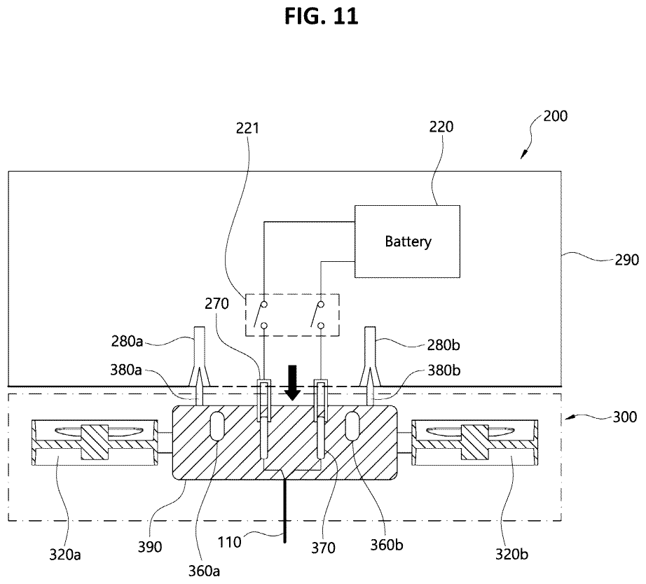

The connection terminal 270 may be electrically connected to the battery 220 (refer to FIG. 10) built into the UAM device 200. The connection terminal 270 may provide electrical energy or power provided from the supply terminal 370 to the battery 220 (refer to FIG. 10) of the UAM device 200. The connection terminal 270 may contain a metal material to smoothly provide electrical energy or power.

The guide pin insertion portions 280a to 280d may be disposed on the lower surface in an area other than the central region. That is, the guide pin insertion portions 280a to 280d may be disposed to be spaced apart from the connection terminal by a predetermined distance.

The guide pin insertion portions 280a to 280d may be positioned to correspond to the guide pins of the power supply drone 300. The guide pin insertion portions 280a to 280d may include the first guide pin insertion portion 280a to the fourth guide pin insertion portion 280d. For example, the first guide pin insertion portion 280a to the fourth guide pin insertion portion 280d may be positioned to correspond to the first guide pin 380a to the fourth guide pin 380d.

The first guide pin insertion portion 280a may be disposed on the left front side of the lower surfaces of the UAM device 200. The second guide pin insertion portion 280b may be disposed on the right front side of the lower surface of the UAM device 200. The third guide pin insertion portion 280c may be disposed on the right rear side of the lower surface of the UAM device 200. The fourth guide pin insertion portion 280d may be disposed on the left rear side of the lower surface of the UAM device 200.

The camera marker 250 may be provided in an area other than the central region and disposed to be spaced apart from the guide pin insertion portions 208a to 280d. The camera marker 250 may be positioned to correspond to the camera 330 of the power supply drone 300.

The camera marker 250 may be provided to be biased toward one side from the central region. Accordingly, when the camera marker 250 is controlled to be positioned at the center of an image captured by the camera 330 of the power supply drone 300, the power supply drone 300 can be caused to accurately approach the UAM device 200.

In addition, the connection terminal protector 275 may be built into the UAM device 200 such that a part thereof is disposed on the lower surface of the UAM device 200 to surround the connection terminal. The connection terminal protector 275 may serve to protect the connection terminal from the outside. The connection terminal protector 275 may be formed to cover the connection terminal disposed on the lower surface of the UAM device 200. The connection terminal protector 275 may perform an opening operation to expose the connection terminal to the outside or a closing operation to protect the supply terminal 370 from the outside under the control of the second controller 310 of the UAM device 200.

The pair of electromagnets 260a and 260b is disposed at the upper part of the inside the body 390 to facilitate docking with/separating from the UAM device 200. It is desirable that the electromagnets 360a and 360b be disposed outside the supply terminal 370 and respectively positioned between the first guide pin 380a and the fourth guide pin 380d and between the second guide pin 380b and the third guide pin 380c.

The pair of electromagnets 260a and 260b may be disposed inside the power receiver 210. It is desirable that the electromagnets 260a and 260b be disposed outside the connection terminal 270 and respectively positioned between the first guide pin inserting portion 280a and the fourth guide pin inserting portion 280d and between the second guide pin inserting portion 280b and the third guide pin inserting portion 280c to facilitate docking with/separating from the power supply drone 300.

That is, it is desirable that the pair of electromagnets 260a and 260b disposed in the UAM device 200 be disposed at positions facing the pair of electromagnets 360a and 360b disposed in the power supply drone 300.

FIG. 9 is a flowchart illustrating a process of a UAM power supply method according to the present disclosure.

The UAM device 200 transmits an external power supply request signal while preparing to land in the sky above the charging station 100 (S901).

Upon reception of the external power supply request signal from the UAM device 200 through the built-in communication module 340, the second controller 310 of the power supply drone 300 transmits a signal representing acceptance of the external power supply request to the UAM device 200. Then, the power supply drone 300 performs a takeoff operation by controlling the propulsion unit 320. The power supply drone 300 is coupled to the lower part of the UAM device 200 in the sky above the charging station 100 using electromagnetic force (S902). The coupling process will be described in detail in the following description using FIG. 15.

The power supply drone 300, which has docked with the UAM device 200, supplies power provided through the power cable 110 connected to the charging station 100 to the UAM device 200 until the battery 220 built in the UAM device 200 is fully charged or take-off of the UAM device 200 is completed (S904). This is because external power necessary for takeoff can be supplied when there is not enough time until the battery is fully charged (S903).

Upon completion of power supply or takeoff, the power supply drone 300 performs an operation of separating from the UAM device 200 (S905).

If there is another UAM device that intends to land at the same charging station 100 nearby when the power supply drone 300 intends to land after supplying power (S906), the power supply drone 20 may attempt to dock with the other UAM device (S907). Upon completion of docking with the other UAM device (S908), the power supply drone 300 may land at the charging station 100 together with the other UAM device (S910) while supplying power to the other UAM device (S909).

On the other hand, if there are no other UAM devices that intend to land at the same charging station 100 nearby when the power supply drone 300 intends to land, the power supply drone 300 descends and lands at the charging/docking station 100. At this time, it is possible to control propulsion in the vertical direction and propulsion in the horizontal direction such that the power cable connected to the ground does not exceed a certain range during landing (S911).

FIG. 10 and FIG. 11 are exemplary diagrams for describing an operation of physically connecting the power supply drone and the UAM device according to an implementation of the present disclosure. Referring to FIG. 10, the power supply drone 300 and the UAM device 200 may approach each other in order to be physically connected to each other according to an implementation of the present disclosure. That is, the power supply drone 300 may gradually approach to dock with the UAM device 200. Alternatively, the UAM device 200 may gradually approach to dock with the power supply drone 300.

The power supply drone 300 and the UAM device 200 may gradually approach each other while the communication module 340 of the power supply drone 300 and the communication module of the UAM device 200 transmit and receive position information and flight information of the power supply drone 300 and the UAM device 200.

The power supply drone 300 may capture an image of the camera marker 250 of the UAM device 200 using the camera 330. The power supply drone 300 may approach the UAM device 200 while controlling the second controller 310 to control the propulsion unit 320 such that the camera marker 250 is positioned at the center of the captured image.

After the power supply drone 300 and the UAM device 200 are physically coupled to each other, the terminal protector 375 of the power supply drone 300 may be gradually opened under the control of the second controller 310 to expose the supply terminal (370) to the outside. In this case, the terminal protector 375 may be built in the power supply drone 300 in a rolled state.

In addition, the connection terminal protector 275 of the UAM device 200 may be gradually opened under the control of the second controller 310 to expose the connection terminal to the outside.

The pair of electromagnets 260a and 260b disposed in the UAM device 200 and the pair of electromagnets 360a and 360b disposed in the power supply drone 300 operate while varying the electromagnetic force thereof according to the distance between the UAM device 200 and the power supply drone 300.

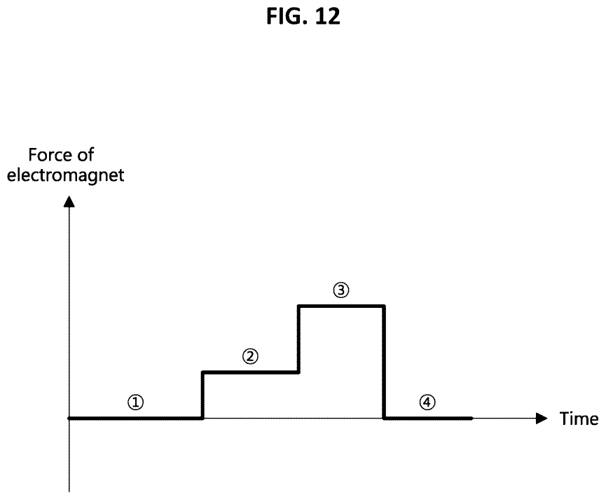

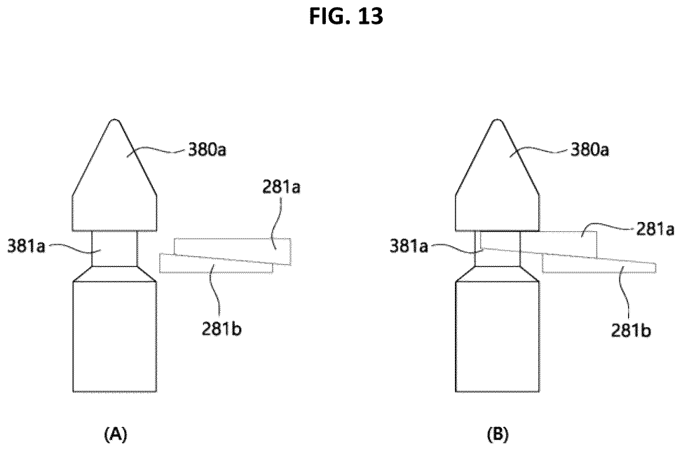

FIG. 12 is a graph showing the attractive force between the electromagnets according to the distance between the power supply drone and the UAM device. That is, as shown in FIG. 12, when the distance to the UAM device 200 is a first distance, the magnitude of the electromagnetic force is controlled to be a first magnitude \textcircled{2} to align the position with respect to the UAM device 200. Here, the electromagnets 260a and 360a and the electromagnets 260b and 360b of the UAM device 200 and the power supply drone 300, which face each other, are controlled to have different polarities. That is, the UAM device 200 and the power supply drone 300 can be relatively easily aligned by the attractive force of the electromagnets, and thus the time required for the UAM device 200 and the power supply drone 300 to dock with each other can be reduced.

When the alignment is completed and the distance to the UAM device 200 is a second distance shorter than the first distance, the magnitude of the electromagnetic force is controlled to be a second magnitude \textcircled{3} such that the power supply drone 300 can come into contact with and dock with the UAM device 200.

Referring to FIG. 10, the power supply drone 300 and the UAM device 200 may be physically connected according to an implementation of the present disclosure. Accordingly, the guide pins 380a to 380d of the power supply drone 300 can be inserted into the guide pin insertion portions 280a to 280d of the UAM device 200, and thus the supply terminal 370 of the power supply drone 300 can be inserted into the connection terminal 270 of the UAM device 200.

Upon determining that the connection terminal 270 is physically connected to the supply terminal 370 of the power supply drone 300, the UAM device 200 may turn on a switch 221 to be provided with electrical energy or power and charge the battery 220 of the UAM device 200 with the electrical energy or power.

In some implementations, the power supply drone 300 may be controlled such that a part or all of the supply terminal 370 is exposed to the outside from the upper surface while the terminal protector 375 is opened. That is, the supply terminal 370 is positioned to protrude from the upper surface like the guide pins and thus can be stably inserted into the connection terminal of the UAM device 200. Accordingly, power and electrical energy can be smoothly supplied.

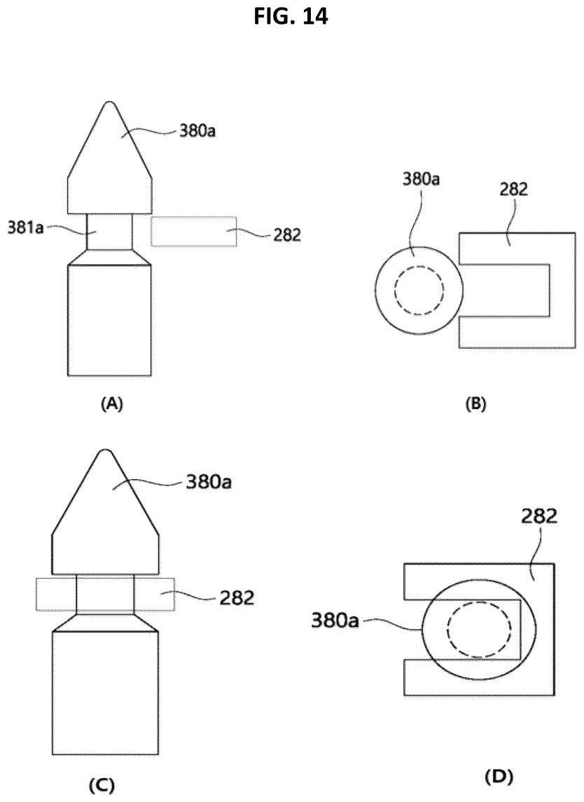

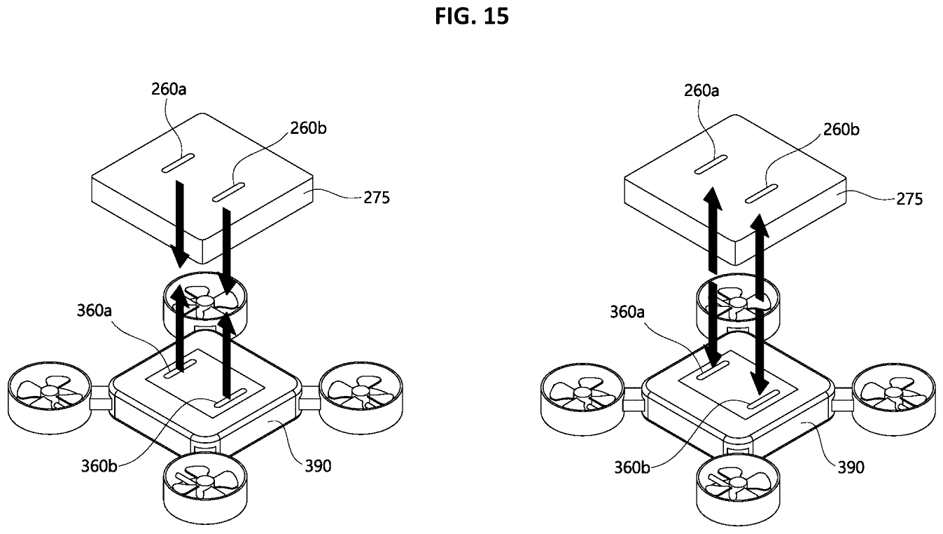

FIG. 13 is an exemplary diagram of a guide pin and a fixing device according to an implementation, and FIG. 14 is an exemplary diagram of a guide pin and a fixing device according to another implementation. Hereinafter, the first guide pin 380a will be described as an example, and the same may be applied to the second to fourth guide pins 380b to 380d.

As shown in (A) of FIG. 13, a recess 381a is formed in a portion of the body of the guide pin 380a, and the fixing device 281 capable of fixing the guide pin 380a is fitted in the guide pin insertion portion 280a. The fixing device 281 includes an upper fixing device 281a and a lower fixing device 281b. In this case, the upper fixing device 281a and the lower fixing device 281b are formed such that the portions facing each other have inclinations. When the guide pin 380a is inserted into the guide pin insertion portion 280a, the upper fixing device 281a moves in the direction of the recess 381a of the guide pin 380a as shown in (B) of FIG. 13, and thus force further pulling the guide pin 380a toward the UAM device 200 can be generated.

(A) to (D) of FIG. 14 show a fixing device 282 formed to have a “C”-shaped plane unlike the implementation of FIG. 13. That is, (B) and (D) of FIG. 14 are plan views showing that the fixing device 282 has a “C”-shaped plane. When the guide pin 380a is inserted into the guide pin insertion portion 280a, the fixing device 282 moves in the direction of the recess 381a formed in the guide pin 380a to fix the guide pin 380a.

FIG. 15 is an exemplary diagram showing that the power supply drone and the UAM device perform docking and separating operations according to polarities of electromagnets.

As shown in (A), when the UAM device 200 and the power supply drone 300 are docked with each other in the sky above the charging/docking station 100, the electromagnets 260a and 360a and the electromagnets 260b and 360b, which face each other, are controlled to have different polarities. For example, when the electromagnet 260a of the UAM device 200 has polarity “N”, the electromagnet 360a of the power supply drone 300 moved to a position corresponding thereto has polarity “S”. Although the electromagnets are used both in the UAM device and the power supply drone in the present disclosure, attraction and repulsion can be generated by providing electromagnets in any one of the power supply drone and the UAM device and providing general magnets in the other.

As shown in (B), when the power supply drone 300 that has completed the charging operation is separated from the UAM device 200, the electromagnet 360a of the power supply drone and the electromagnet 260a of the UAM device 200, which face each other, have the same polarity after the fixing device is separated from the guide pins. Accordingly, repulsive force is generated due to the same polarity, and thus the power supply drone 300 can be easily separated from the UAM device 200.

As described above, according to the UAM power supply system and method according to the present disclosure, the UAM device and the power supply drone can be relatively easily aligned using electromagnetic force when they are docked with or separated from each other, and thus the time taken for docking can be reduced. Further, the UAM device and the power supply drone can be fixed to each other using electromagnetic force before being fixed with a physical fixing device, and thus it is possible to prevent the UAM device and the power supply drone from leaving from fixed positions thereof during the operation of the physical fixing device. In addition, the UAM device and the power supply drone are brought into contact with each other using electromagnetic force in the process of separating the UAM device and the power supply drone from each other, and thus load applied to the physical fixing device can be reduced to easily release the physical fixing device from the guide pins.

In addition to the implementations of the present disclosure described above, those skilled in the art can understand that the present disclosure can be modified and changed in various manners within the scope without departing from the spirit and scope of the present disclosure described in the claims.

In the UAM power supply system and method according to the present disclosure, the power supply drone can be docked with the UAM device in the sky and supply power to the UAM device above the charging station and then safely return to the ground. In addition, the UAM device and the power supply drone can be aligned and docked with each other in a correct direction and location using electromagnetic force. Further, when the UAM device and the power supply drone are docked with each other or separated from each other, the time taken for docking can be reduced because they can be aligned relatively easily using electromagnetic force. Further, since they are fixed to each other using electromagnetic force before being fixed with a physical fixing device, it is possible to prevent the UAM device and the power supply drone from leaving fixed positions thereof during the operation of the physical fixing device. In addition, it is possible to reduce load applied to the physical fixing device by fixing the UAM device and the power supply drone to each other using electromagnetic force in the process of separating the power supply drone from the UAM device, thereby easily releasing the physical fixing device from the guide pins.

What is claimed is:

1. A method for supplying power to an urban air mobility (UAM) device, the method comprising:
receiving an external power supply request signal from the UAM device in a sky;
coupling a power supply drone to the UAM device based on reception of the external power supply request signal from the UAM device; and
supplying power to the UAM device by the power supply drone through a power cable that is connected to a charging station.

2. The method according to claim 1, wherein coupling the power supply drone to the UAM device comprises applying electromagnetic force between the power supply drone and the UAM device in the sky.

3. The method according to claim 1, further comprises:
controlling the power supply drone to take off based on the power supply drone coupling to the UAM device; and
separating the power supply drone from the UAM device based on a completion of charging of the UAM device.

4. The method according to claim 2, wherein coupling the power supply drone to the UAM device comprises:
aligning a position of the power supply drone with respect to the UAM device by adjusting a magnitude of the electromagnetic force to a first magnitude based on a distance from the power supply drone to the UAM device corresponding to a first distance; and
bringing the power supply drone into contact with the UAM device by adjusting the magnitude of the electromagnetic force to a second magnitude based on the distance from the power supply drone to the UAM device becoming a second distance that is less than the first distance.

5. The method according to claim 3, wherein separating the power supply drone from the UAM device comprises controlling at least one of a first electromagnet disposed at the UAM device or a second electromagnet disposed at the power supply drone to thereby arrange same polarities of the first and second electromagnets to face each other.
